(19) United States
(12) Patent Application Publication
(10) Pub. No.: US 2026/0058734 A1
(43) Pub. Date: Feb. 26, 2026

(54) RADIO COEXISTENCE VIA ORTHOGONAL FIELD DE-COUPLING

(71) Applicant: Cisco Technology, Inc., San Jose, CA (US)

(72) Inventors: Navid POURRAMZANGANDJI, Copley, OH (US); Sivadeep R. KALAVAKURU, Pleasanton, CA (US); Jonathan M. CYPHERT, Richfield, OH (US)

(21) Appl. No.: 18/812,742

(22) Filed: Aug. 22, 2024

(51) Int. Cl. H04B 15/00

(52) U.S. Cl. CPC H04B 15/00

(57) ABSTRACT

Techniques and structures for improved radio coexistence via orthogonal field de-coupling are provided. An apparatus is disclosed, comprising a first dipole antenna, a second dipole antenna, where a plane of the second dipole antenna is parallel to a plane of the first dipole antenna, and a major axis of the second dipole antenna is perpendicular to a major axis of the first dipole antenna, and a dielectric material between the first and second dipole antennas.

### TECHNICAL FIELD

Embodiments presented in this disclosure generally relate to wireless communication. More specifically, embodiments disclosed herein relate to improving radio coexistence with reduced interference.

### BACKGROUND

Many wireless communication devices communicate using radio frequency (RF) signals in a variety of frequencies. Often, signals in frequencies that overlap or are near to each other can interfere with each other, reducing (or eliminating) the ability of one or both signals to be used simultaneously. Many modern wireless devices include multiple radios and/or antennas to communicate in multiple frequency bands. Additionally, devices (such as access points (AP)) have recently been introduced with an increasing numbers of transmitter/receiver (Tx/Rx) pairs, enabling more parallel communication (e.g., higher throughput and bandwidth). Further, the portion(s) of such devices used to house the antenna(s) for each Tx/Rx pair (sometimes referred to as antenna farms) have been growing to accommodate more antenna elements (e.g., sixteen or more elements in some designs).

This increasing number of elements has caused device design to become increasingly complex, and has further resulted in substantial inter-element interaction in some cases. For example, interference between co-located antennas (e.g., antennas in the same device or within a relatively close proximity to each other) can cause nulls in the signals, higher ripple in the patterns, and/or lower isolation between the radios. These effects and others can significantly hamper co-located radios, particularly those operating in the same or adjacent frequency bands, as one radio (referred to in some aspects as the aggressor) may be transmitting at or near the band edge, while other radio(s) (referred to in some aspects as the victim) is trying to receive. With such reduced isolation between antennas, many wireless devices are forced to reduce transmit power of the aggressor by a substantial amount (e.g., greater than twelve decibels) to prevent or mitigate de-sensitizing of the co-located radio(s).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts example antenna designs to mitigate interference via orthogonal field decoupling, according to some embodiments of the present disclosure.

FIG. 2 depicts an example bowtie dipole configuration for orthogonal field decoupling, according to some embodiments of the present disclosure.

FIG. 3 depicts an example magnetic loop configuration for orthogonal field decoupling, according to some embodiments of the present disclosure.

FIG. 4 depicts a side view of an example antenna configuration for orthogonal field decoupling, according to some embodiments of the present disclosure.

FIG. 5 depicts a side view of an example antenna configuration with pillars for orthogonal field decoupling, according to some embodiments of the present disclosure.

FIG. 6 depicts an isometric view of an example antenna configuration for orthogonal field decoupling, according to some embodiments of the present disclosure.

FIG. 7 depicts an example wireless device with co-located radios configured for orthogonal field decoupling, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a wireless device, comprising: a first wireless radio configured to operate in a first set of frequency bands; a second wireless radio configured to operate in a second set of frequency bands; a first dipole antenna coupled to the first wireless radio; and a second dipole antenna coupled to the second wireless radio, wherein a plane of the second dipole antenna is parallel to a plane of the first dipole antenna, and the second dipole antenna is orthogonal to the first dipole antenna.

One embodiment presented in this disclosure is an apparatus, comprising: a first dipole antenna; a second dipole antenna, wherein a plane of the second dipole antenna is parallel to a plane of the first dipole antenna, and a major axis of the second dipole antenna is perpendicular to a major axis of the first dipole antenna; and a dielectric material between the first and second dipole antennas.

One embodiment presented in this disclosure is an access point (AP), comprising: a first wireless radio comprising a first plurality of transceiver elements and configured to operate in a first set of frequency bands; a second wireless radio comprising a second plurality of transceiver elements and configured to operate in a second set of frequency bands; a first dipole antenna coupled to a first transceiver element of the first set of transceiver elements; a second dipole antenna coupled to a first transceiver element of the second plurality of transceiver elements, wherein a plane of the second dipole antenna is parallel to a plane of the first dipole antenna, and the second dipole antenna is orthogonal to the first dipole antenna; a third dipole antenna coupled to a second transceiver element of the first plurality of transceiver elements; and a fourth dipole antenna coupled to a second transceiver element of the second wireless radio, wherein a plane of the third dipole antenna is parallel to a plane of the fourth dipole antenna, and the fourth dipole antenna is orthogonal to the third dipole antenna.

### Example Embodiments

Embodiments of the present disclosure provide techniques, designs, and configurations for antenna elements with improved isolation and reduced antenna farm footprint via orthogonal field decoupling.

In some embodiments, using the configurations described herein, the size of the antenna farm of a wireless device can be substantially decreased, allowing for reduced dimensionality of the device itself while also mitigating or reducing co-located radio interference, as compared to some conventional designs. Generally, the disclosed configurations are compatible with a wide variety of antenna conductor designs. Some examples described in more detail below include use of magnetic loop elements, bowtie elements, and the like. In some embodiments, any dipole antenna design may be used in accordance with examples described herein. In some aspects, any planar dipole antennas can be used in accordance with examples described herein.

In some embodiments, an antenna element having two conductors (e.g., two antennas) is provided, where the conductors are located on either side of a separating material (e.g., a dielectric material) and are arranged perpendicular to each other. In some embodiments, in the case of planar antenna, the planes of the antennas are parallel and the center of each element is aligned in the vertical axis, while the major and minor axes are configured at a ninety degree angle. For example, in some embodiments, an upper element and a lower element can be arranged such that the planes of the antennas are parallel, the centers of each element are aligned on the vertical axis (perpendicular to the plane of the antennas), the major axis of the upper antenna is aligned with the minor axis of the lower antenna, and the minor axis of the upper antenna is aligned with the major axis of the lower antenna. In some aspects, the antenna element can use two antenna structures having matching designs (e.g., two bowtie dipoles, two magnetic loops, and the like).

In some embodiments, two RF chains (e.g., two Tx/Rx pairs, where each Tx/Rx pair may be referred to collectively as a transceiver and/or a transceiver element) may be connected to each antenna element (one to each conductor). In some embodiments, for two radios that are co-located or need to co-exist (e.g., two radios on a single wireless device), RF chain(s) from one radio may connect to the upper conductor(s) of one or more antenna elements, and RF chain(s) from the other radio may connect to the lower conductor(s) of the one or more antenna elements. For example, if each radio has four RF chains, the wireless device may comprise four antenna element (each with two conductors—one upper and one lower), where the RF chains of one radio each connect to a respective upper conductor (one on each element) and the RF chains of the other radio each connect to a respective lower conducted (one on each element).

In some embodiments, the perpendicular arrangement of such conductors on each antenna element can create orthogonal electric fields between the top and bottom structures. In other words, the electric field and current direction of the top and bottom structures may be orthogonal in nature. In some embodiments, this configuration can substantially reduce the induced current in the lower conductor from the electric field of the upper structure (and vice versa). As the induced current is reduced, the new fields created by the induced current is similarly reduced, which results in significantly improved (e.g., higher) isolation between the upper and lower antenna structures. In some embodiments, die casting pillars may be formed to further increase the vertical separation between the conductors, which may further reduce field interaction, resulting in further improved isolation.

Generally, the amount of isolation that can be obtained between the conductors may vary depending on the particular implementation (e.g., the particular antenna conductor design, dielectric material, spacing, frequency band, and the like) due to varying reflections and induction current. In some embodiments, using the configurations described herein can enable substantial isolation, such as isolation equal to or greater than about 35 decibels (dB) (e.g., within +/− two dB), equal to or greater than about 40 dB, equal to or greater than about 45 dB, equal to or greater than about 50 dB, equal to or greater than about 55 dB, equal to or greater than about 60 dB, and the like (depending on the particular implementation). For example, at the 6.5 GHz frequency band, isolation may be about 60 dB.

Further, as discussed above, the vertical alignment of the conductors on each antenna element enables substantial reductions in physical size of the antenna farm. For example, the number of antenna elements may be halved (e.g., from eight to four) by this combination of two conductors per element, enabling smaller wireless device size while also providing improved multi-radio coexistence.

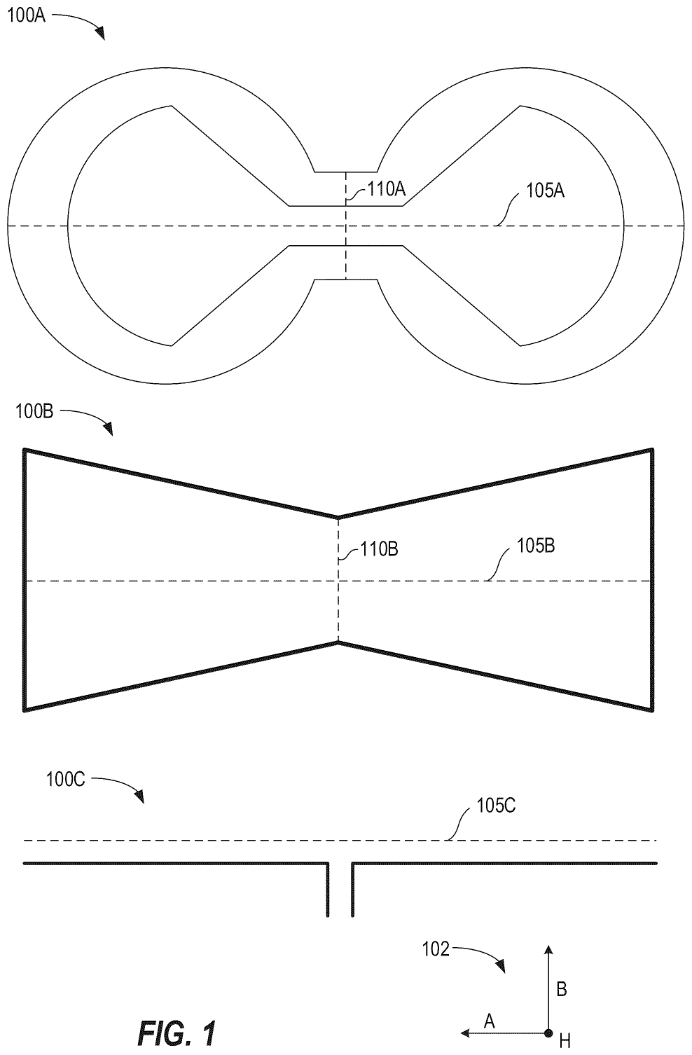

FIG. 1 depicts example antenna designs 100 to mitigate interference via orthogonal field decoupling, according to some embodiments of the present disclosure.

In the illustrated example, three antenna designs 100A, 100B, and 100C are depicted. However, as discussed above, embodiments of the present disclosure are not limited to these designs, and any number and variety of antenna conductor designs may be used in accordance with embodiments of the present disclosure. In some embodiments, each of the antenna designs 100 comprises a dipole and/or magnetic loop structure. In some embodiments, some of the antenna designs 100 have a planar structure.

For example, the antenna design 100A corresponds to a magnetic loop conductor in a figure-eight or “infinity” pattern. In the illustrated example, the antenna design 100A has a planar structure, where the major axis 105A of the antenna design 100A is perpendicular to the minor axis 110A of the antenna design 100A. As used herein, the major axis 105A and the minor axis 110A form the plane of the antenna design 100A. In some aspects, the major axis 105A and minor axis 110A may be referred to as the horizontal plane or axes, while the vertical axis extends perpendicular to both the major axis 105A and the minor axis 110A (e.g., into and out of the page in the illustrated design). For example, referring to the key 102, the major axis 105A of the antenna design 100A is along the axis labeled “A,” the minor axis 110A of the antenna design 100A is along the axis labeled “B,” and the vertical axis of the antenna design 100A is along the axis labeled “H” (e.g., the height of the antenna). In some embodiments, as discussed in more detail below, the antenna design 100A can be used as one conductor of an antenna element (e.g., the upper structure), where another matching conductor can be arranged directly below the antenna design 100A (e.g., with the center of each aligned along the vertical axis “H”), and the lower element rotated ninety degrees around the vertical axis (e.g., such that the major axis of the lower element is along the axis labeled “B” in the key 102 and the minor axis of the lower element is along the axis labeled “A”in the key 102).

The antenna design 100B corresponds to a bowtie conductor (e.g., a dipole antenna). In the illustrated example, the antenna design 100B also has a planar structure, where the major axis 105B of the antenna design 100B is perpendicular to the minor axis 110B of the antenna design 100B. As discussed above, the major axis 105B and the minor axis 110B form the plane of the antenna design 100B. In some aspects, the vertical axis of the antenna design 100B extends perpendicular to both the major axis 105B and the minor axis 110B (e.g., into and out of the page in the illustrated design). For example, referring to the key 102, the major axis 105B of the antenna design 100B is along the axis labeled “A,” the minor axis 110B of the antenna design 100B is along the axis labeled “B,” and the vertical axis of the antenna design 100B is along the axis labeled “H” (e.g., the height of the antenna). In some embodiments, as discussed in more detail below, the antenna design 100B can also be used as one conductor of an antenna element (e.g., the upper structure), where another matching conductor can be arranged directly below the antenna design 100B (e.g., with the center of each aligned along the vertical axis “H”), and the lower element rotated ninety degrees around the vertical axis (e.g., such that the major axis of the lower element is along the axis labeled “B” in the key 102 and the minor axis of the lower element is along the axis labeled “A”in the key 102).

The antenna design 100C corresponds to a linear dipole conductor. In the illustrated example, the antenna design 100C has a linear structure, where the major axis 105C of the antenna design 100C indicates the “long” side of the antenna (e.g., where each element may be a single wire or conductor extending horizontally along the major axis 105C). In some embodiments, the major axis 105C of the antenna design 100C may act as the plane of the antenna design 100C, where the vertical axis is any axis perpendicular to the major axis 105C. For example, referring to the key 102, the major axis 105C of the antenna design 100C is along the axis labeled “A,” there is no minor axis of the antenna design 100C, and the vertical axis of the antenna design 100C may be along any axis perpendicular to the axis labeled “A,” including along the axis labeled “H,” along the axis labeled “B,” and any angle between. In some embodiments, as discussed in more detail below, the antenna design 100C can also be used as one conductor of an antenna element (e.g., the upper structure), where another matching conductor can be arranged directly below the antenna design 100C (e.g., with the center of each aligned along the vertical axis “H”), and the lower element rotated ninety degrees around the vertical axis (e.g., such that the major axis of the lower element is perpendicular to the major axis of the lower element).

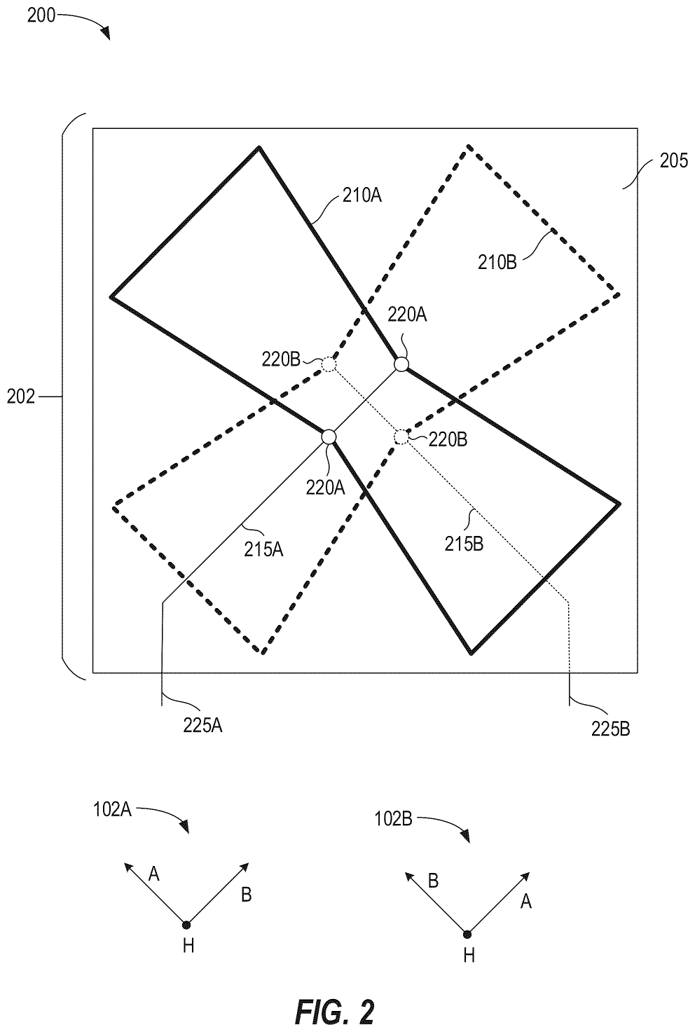

FIG. 2 depicts an example bowtie dipole configuration 200 for orthogonal field decoupling, according to some embodiments of the present disclosure. Specifically, FIG. 2 depicts a top view of the configuration 200, where the planes of the depicted antenna are parallel with the plane of the view.

In the illustrated example, an antenna element 202 comprises two conductors 210A and 210B (collectively, the conductors 210) separated by a dielectric material 205. The dielectric material 205 can generally correspond to or comprise any suitable material, such as ceramic, plastic, mica, glass, polyethylene, paper, and the like. The thickness of the dielectric material may vary depending on the particular implementation. Although the illustrated example depicts a square dielectric material 205, in aspects, the particular shape and size of the dielectric material may vary depending on the particular implementation. In some embodiments, the dielectric material 205 may be sufficiently sized and shaped to cover the footprint of both of the conductors 210 (e.g., such that each section of each of the conductors 210 can be firmly mounted to or embedded in the dielectric material 205 to provide support).

Generally, each of the conductors 210 may correspond to or comprise any suitable material for an antenna. For example, the conductors 210 may be constructed using (without limitation) any combination of conductive materials such as copper, aluminum, silver, gold, and the like. In the illustrated example, the conductors 210 are bowtie dipoles. However, in some embodiments, the design of the conductors 210 may vary depending on the particular implementation, and may correspond to (without limitation) the antenna designs 100A, 100B, and/or 100C of FIG. 1. Generally, the particular size and shape of each conductor 210 may vary depending on the particular implementation (e.g., based on the frequency band(s) in which the antennas will be used). For example, the length of the major axis, the length of the minor axis, the width of the constricted area at the center of each bowtie, and the like may all vary depending on the particular implementation.

In the illustrated example, the conductors 210 include an upper conductor 210A (depicted using solid lines) and a lower conductor 210B (depicted using dashed lines). In some embodiments, the lower conductor 210B is on an opposite side of the dielectric material 205, relative to the upper conductor 210A. Each conductor 210 may generally be disposed on, in, or above (or below, as appropriate) the dielectric material 205.

In the illustrated configuration, the conductors 210 are arranged or configured in an orthogonal manner, where the centers of the conductors 210 are aligned in the vertical dimension (e.g., the “H” axis of the image, parallel to the planes of the conductors 210) but are offset along this axis (e.g., above and below the dielectric) and are rotated orthogonally about the vertical axis (e.g., such that the major axis of the lower conductor 210B is perpendicular to the major axis of the upper conductor 210A). That is, in the illustrated example, the planes of each conductor 210 are parallel (e.g., they share the same vertical axis, as indicated by the keys 102A-B). As depicted by the key 102A (which corresponds to the upper conductor 210A) and the key 102B (which corresponds to the lower conductor 210B), the major axis of the upper conductor 210A is parallel with the minor axis of the lower conductor 210B, the minor axis of the upper conductor 210A is parallel with the major axis of the lower conductor 210B, and the major axes of the upper conductor 210A and the lower conductor 210B are orthogonal (e.g., perpendicular) to each other.

As discussed above, this arrangement can cause the conductors 210 to create electric fields that are similarly orthogonal to each other, which can allow the conductors 210 to be used in the same (or neighboring) frequency bands with substantially reduced interference between them. That is, the upper conductor 210A may be used by a first radio operating in a first set of one or more frequency bands while the lower conductor 210B is used by a second radio operating in a second set of one or more frequency bands, where the first and second sets of frequency bands may be entirely overlapping (e.g., the same set of bands), partially overlapping, or neighboring or adjacent to each other.

In the illustrated example, the antenna element 202 includes two connections 225A and 225B to connect the conductors 210A-B to respective radios. Specifically, the conductor 210A may be connected to a radio via the connection 225A, and the conductor 210B may be connected to a radio via the connection 225B. As illustrated, each conductor 210 is excited via two points 220, one on each side of the bowtie. Specifically, the conductor 210A is excited via the points 220A, and the conductor 210B is excited via the points 220B.

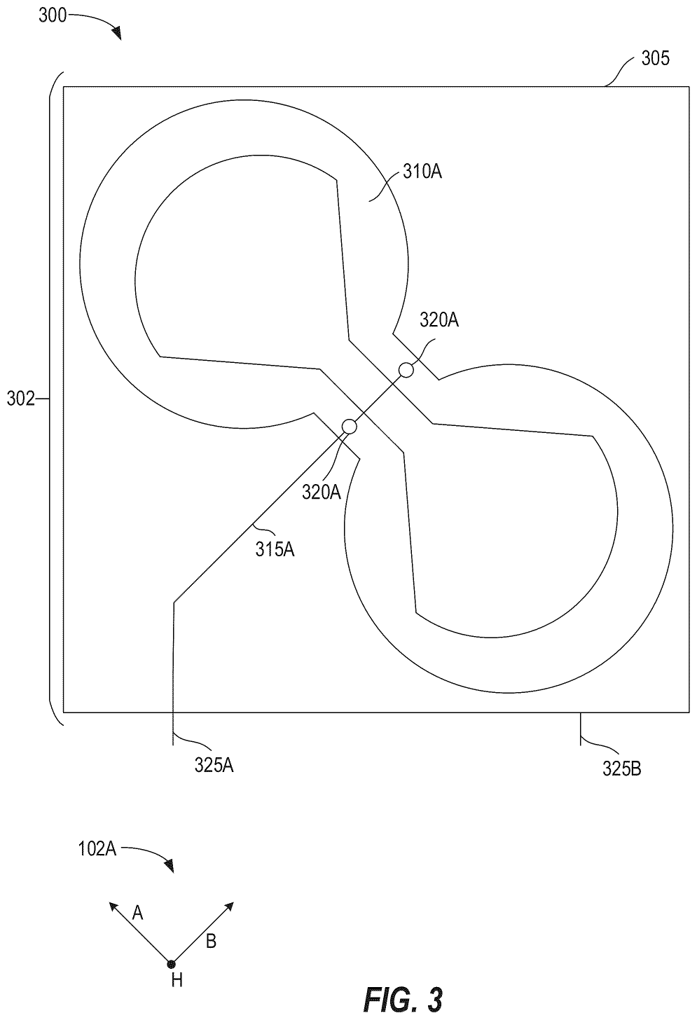

FIG. 3 depicts an example magnetic loop configuration 300 for orthogonal field decoupling, according to some embodiments of the present disclosure. Specifically, FIG. 3 depicts a top view of the configuration 300, where the planes of the depicted antenna are parallel with the plane of the view.

In the illustrated example, an antenna element 302 comprises two conductors separated by a dielectric material 305. For conceptual clarity, only the upper conductor 310A is depicted. As discussed above, the dielectric material 305 can generally correspond to or comprise any suitable material, and the thickness, size, and shape of the dielectric material may vary depending on the particular implementation. Further, each of the conductors 310 may correspond to or comprise any suitable material, and the particular size and shape of each conductor 310 may vary depending on the particular implementation (e.g., based on the frequency band(s) in which the antennas will be used).

In the illustrated example, the conductors 310 are magnetic loop conductors in an “infinity” or “figure eight” shape. However, in some embodiments, the design of the conductors 310 may vary depending on the particular implementation, and may correspond to (without limitation) the antenna designs 100A, 100B, and/or 100C of FIG. 1. In the illustrated example, the upper conductor 310A is depicted using solid lines. As discussed above, in some embodiments, the lower conductor is on an opposite side of the dielectric material 305, relative to the upper conductor 310A, and each conductor 310 may generally be disposed on, in, or above (or below, as appropriate) the dielectric material 305.

In the illustrated configuration, the conductors 310 are arranged or configured in an orthogonal manner, where the centers of the conductors 310 are aligned in the vertical dimension (e.g., the “H” axis of the image, parallel to the planes of the conductors 310) but are offset along this axis (e.g., above and below the dielectric) and are rotated orthogonally about the vertical axis (e.g., such that the major axis of the lower conductor is perpendicular to the major axis of the upper conductor 310A). That is, in the illustrated example, the planes of each conductor 310 are parallel (e.g., they share the same vertical axis, as indicated by the key 102A). As depicted by the key 102A (which corresponds to the upper conductor 210A), the major axis of the upper conductor 310A is parallel with the minor axis of the lower conductor, the minor axis of the upper conductor 310A is parallel with the major axis of the lower conductor, and the major axes of the upper conductor 310A and the lower conductor are orthogonal (e.g., perpendicular) to each other.

As discussed above, this arrangement can cause the conductors 310 to create electric fields that are similarly orthogonal to each other, which can allow the conductors 310 to be used in the same (or adjacent) frequency bands with substantially reduced interference between them.

In the illustrated example, the antenna element 302 includes two connections 325A and 325B to connect the conductors 310 to respective radios. Specifically, the conductor 310A may be connected to a radio via the connection 325A, and the lower conductor may be connected to a radio via the connection 325B. As illustrated, the conductors are excited via two points 320, one on each side of the infinity loop. Specifically, the conductor 310A is excited via the points 320A.

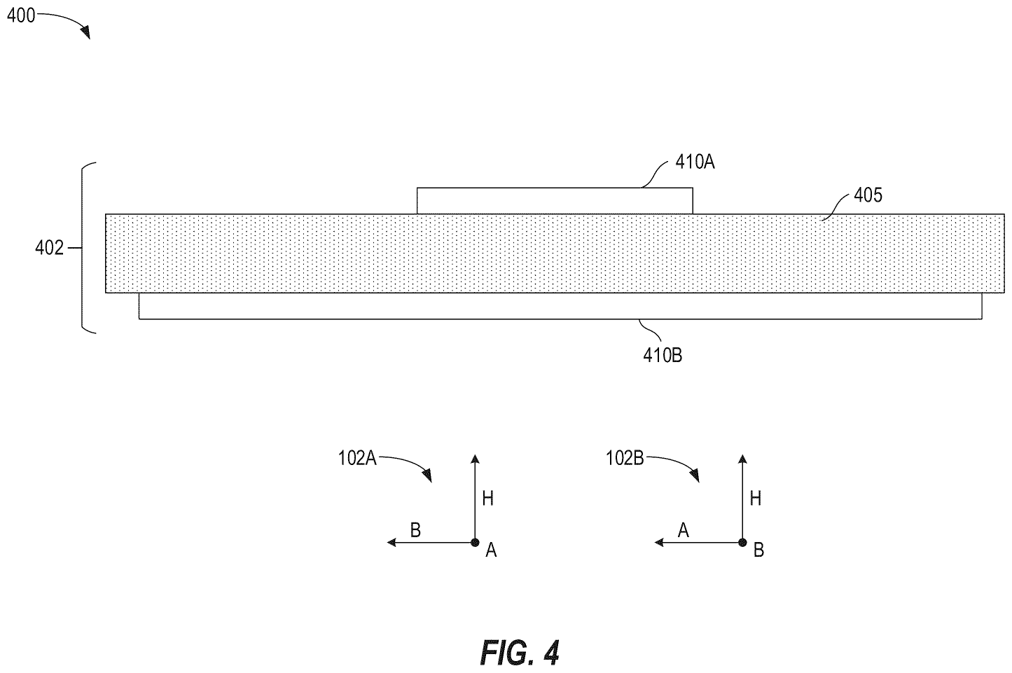

FIG. 4 depicts a side view of an example antenna configuration 400 for orthogonal field decoupling, according to some embodiments of the present disclosure. Specifically, FIG. 4 depicts a side view of the configuration 400, where the planes of the depicted antenna are perpendicular to the plane of the view.

In the illustrated example, an antenna element 402 comprises two conductors 410A and 410B (collectively, the conductors 410) separated by a dielectric material 405. In some aspects, the antenna element 402 corresponds to the antenna element 202 of FIG. 2 and/or the antenna element 302 of FIG. 3. As discussed above, the dielectric material 405 can generally correspond to or comprise any suitable material, and the thickness, size, and shape of the dielectric material may vary depending on the particular implementation. Further, each of the conductors 410 may correspond to or comprise any suitable material, and the particular size and shape of each conductor 410 may vary depending on the particular implementation (e.g., based on the frequency band(s) in which the antennas will be used). Generally, the design of the conductors 410 may vary depending on the particular implementation, and may correspond to (without limitation) the antenna designs 100A, 100B, and/or 100C of FIG. 1.

In the illustrated example, the conductors 410 include an upper conductor 410A (depicted on a top surface of the dielectric material 405) and a lower conductor 410B (depicted on a lower surface of the dielectric material, opposite the top surface). Although depicted as being located on the surfaces of the dielectric material 405, in some aspects, each of the conductors 410 may generally be disposed on, in, or above (or below, as appropriate) the dielectric material 405.

In the illustrated configuration, the conductors 410 are arranged or configured in an orthogonal manner, where the centers of the conductors 410 are aligned in their local vertical dimension (e.g., the “H” axis of the image, parallel to the planes of the conductors 410) but are offset along this axis (e.g., above and below the dielectric) and are rotated orthogonally about the vertical axis (e.g., such that the major axis of the lower conductor 410B is perpendicular to the major axis of the upper conductor 410A). That is, in the illustrated example, the planes of each conductor 410 are parallel (e.g., they share the same vertical axis, as indicated by the keys 102A-B). As depicted by the key 102A (which corresponds to the upper conductor 410A) and the key 102B (which corresponds to the lower conductor 410B), the minor axis of the upper conductor 410A is parallel with the major axis of the lower conductor 410B, the major axis of the upper conductor 410A is parallel with the minor axis of the lower conductor 410B, and the major axes of the upper conductor 410A and the lower conductor 410B are orthogonal (e.g., perpendicular) to each other.

As discussed above, this arrangement can cause the conductors 410 to create electric fields that are similarly orthogonal to each other, which can allow the conductors 410 to be used in the same (or neighboring) frequency bands with substantially reduced interference between them. Although not depicted in the illustrated example, in some embodiments, the antenna element 402 may include two connections to couple the conductors 410A-B to respective radios. Specifically, the conductor 410A may be connected to a first radio and the conductor 410B may be connected to a second radio.

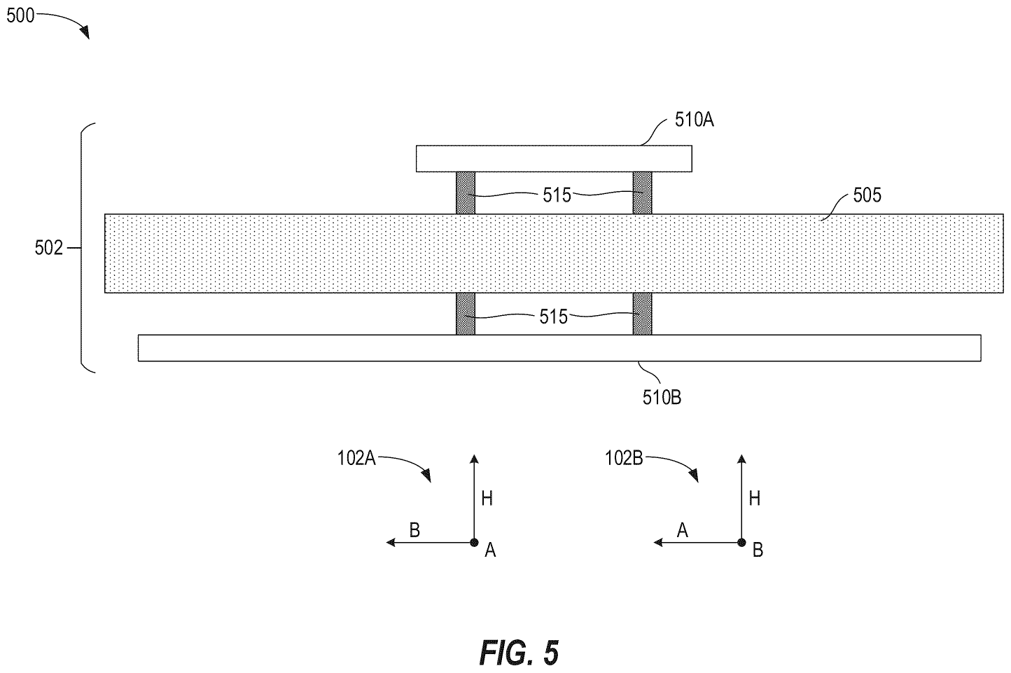

FIG. 5 depicts a side view of an example antenna configuration 500 with pillars for orthogonal field decoupling, according to some embodiments of the present disclosure. Specifically, FIG. 5 depicts a side view of the configuration 500, where the planes of the depicted antenna are perpendicular to the plane of the view.

In the illustrated example, an antenna element 502 comprises two conductors 510A and 510B (collectively, the conductors 510) separated by a dielectric material 505 and a set of pillars 515. In some aspects, the antenna element 502 corresponds to the antenna element 202 of FIG. 2, the antenna element 302 of FIG. 3, and/or the antenna element 402 of FIG. 4. As discussed above, the dielectric material 505 can generally correspond to or comprise any suitable material, and the thickness, size, and shape of the dielectric material may vary depending on the particular implementation. Further, each of the conductors 510 may correspond to or comprise any suitable material, and the particular size and shape of each conductor 510 may vary depending on the particular implementation (e.g., based on the frequency band(s) in which the antennas will be used). Generally, the design of the conductors 510 may vary depending on the particular implementation, and may correspond to (without limitation) the antenna designs 100A, 100B, and/or 100C of FIG. 1.

In the illustrated example, the conductors 510 include an upper conductor 510A (depicted on a top surface of the dielectric material 505) and a lower conductor 510B (depicted on a lower surface of the dielectric material, opposite the top surface). Although depicted as being located on the surfaces of the dielectric material 505, in some aspects, each of the conductors 510 may generally be disposed on, in, or above (or below, as appropriate) the dielectric material 505.

In the illustrated configuration, the conductors 510 are arranged or configured in an orthogonal manner, where the centers of the conductors 510 are aligned in their local vertical dimension (e.g., the “H” axis of the image, parallel to the planes of the conductors 510) but are offset along this axis (e.g., above and below the dielectric) and are rotated orthogonally about the vertical axis (e.g., such that the major axis of the lower conductor 510B is perpendicular to the major axis of the upper conductor 510A). That is, in the illustrated example, the planes of each conductor 510 are parallel (e.g., they share the same vertical axis, as indicated by the keys 102A-B). As depicted by the key 102A (which corresponds to the upper conductor 510A) and the key 102B (which corresponds to the lower conductor 510B), the minor axis of the upper conductor 510A is parallel with the major axis of the lower conductor 510B, the major axis of the upper conductor 510A is parallel with the minor axis of the lower conductor 510B, and the major axes of the upper conductor 510A and the lower conductor 510B are orthogonal (e.g., perpendicular) to each other.

In the illustrated example, in addition to the presence of a solid dielectric material 505, the conductors 510 are further separated using a set of pillars 515 (e.g., cast pillars). That is, rather than being disposed directly on or in the dielectric material 505, the conductors 510 may be supported by pillars 515 which are attached to the dielectric material 505 (and may themselves be made of dielectric material), further increasing the distance between the conductors 510. Further, in many cases, air acts as a dielectric material as well. Therefore, using the pillars 515, the conductors 510 can be further electrically isolated, further reducing potential interference.

As discussed above, this arrangement can cause the conductors 510 to create electric fields that are similarly orthogonal to each other, which can allow the conductors 510 to be used in the same (or neighboring) frequency bands with substantially reduced interference between them. Although not depicted in the illustrated example, in some embodiments, the antenna element 502 may include two connections to couple the conductors 510A-B to respective radios. Specifically, the conductor 510A may be connected to a first radio and the conductor 510B may be connected to a second radio.

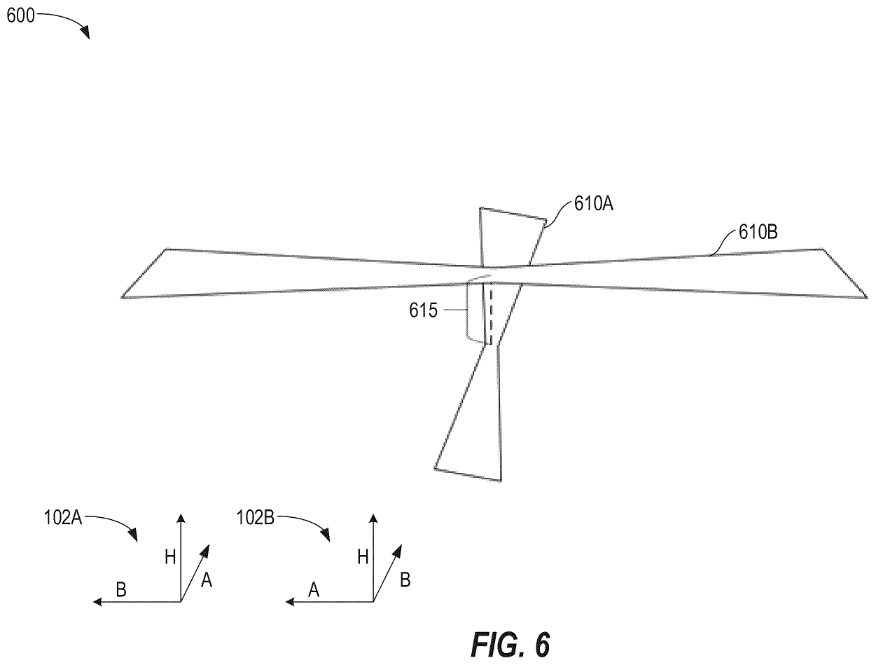

FIG. 6 depicts an isometric view of an example antenna configuration 600 for orthogonal field decoupling, according to some embodiments of the present disclosure. Specifically, FIG. 6 depicts a perspective or isometric view of the configuration 600.

In the illustrated example, an antenna element comprises two conductors 610A and 610B (collectively, the conductors 610) separated by a distance 615 (e.g., a dielectric material). In some aspects, the antenna element corresponds to the antenna element 202 of FIG. 2, the antenna element 302 of FIG. 3, the antenna element 402 of FIG. 4, and/or the antenna element 502 of FIG. 5. As discussed above, the dielectric material can generally correspond to or comprise any suitable material, and the thickness, size, and shape of the dielectric material may vary depending on the particular implementation. Further, each of the conductors 610 may correspond to or comprise any suitable material, and the particular size and shape of each conductor 610 may vary depending on the particular implementation (e.g., based on the frequency band(s) in which the antennas will be used). Generally, the design of the conductors 610 may vary depending on the particular implementation, and may correspond to (without limitation) the antenna designs 100A, 100B, and/or 100C of FIG. 1.

In the illustrated example, the conductors 610 include an upper conductor 610A and a lower conductor 610B. In the illustrated configuration, the conductors 610 are arranged or configured in an orthogonal manner, where the centers of the conductors 610 are aligned in their local vertical dimension (e.g., the “H” axis of the image, parallel to the planes of the conductors 610) but are offset along this axis (e.g., above and below the dielectric, separated by the distance 615) and are rotated orthogonally about the vertical axis (e.g., such that the major axis of the lower conductor 610B is perpendicular to the major axis of the upper conductor 610A). That is, in the illustrated example, the planes of each conductor 610 are parallel (e.g., they share the same vertical axis, as indicated by the keys 102A-B). As depicted by the key 102A (which corresponds to the upper conductor 610A) and the key 102B (which corresponds to the lower conductor 610B), the minor axis of the upper conductor 610A is parallel with the major axis of the lower conductor 610B, the major axis of the upper conductor 610A is parallel with the minor axis of the lower conductor 610B, and the major axes of the upper conductor 610A and the lower conductor 610B are orthogonal (e.g., perpendicular) to each other.

As discussed above, this arrangement can cause the conductors 610 to create electric fields that are similarly orthogonal to each other, which can allow the conductors 610 to be used in the same (or neighboring) frequency bands with substantially reduced interference between them.

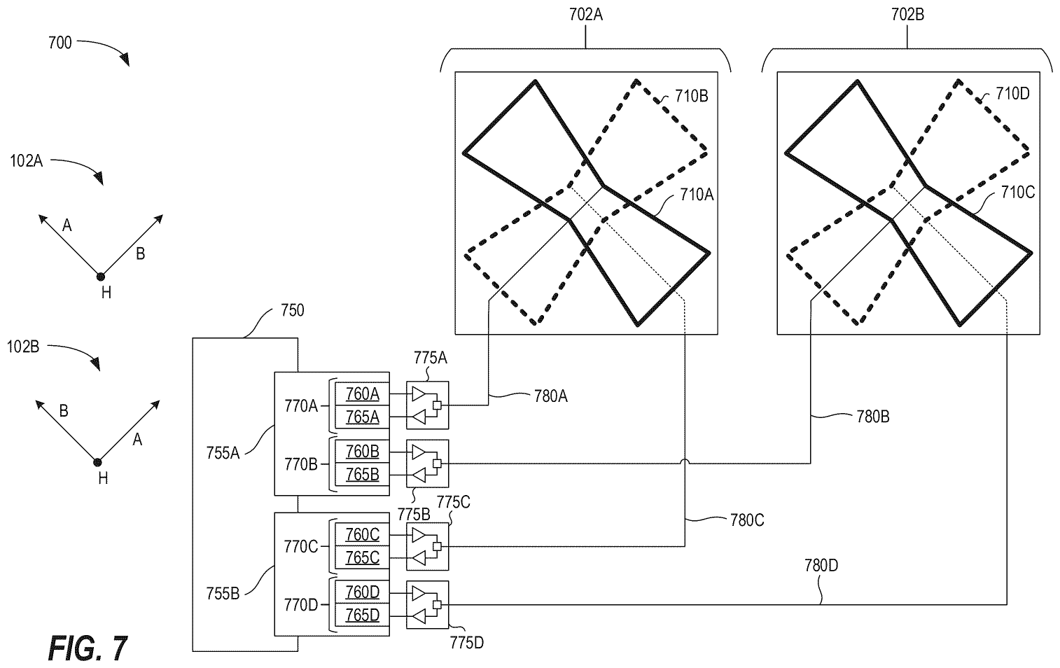

FIG. 7 depicts an example wireless device 700 with co-located radios configured for orthogonal field decoupling, according to some embodiments of the present disclosure. For example, the wireless device 700 may be an access point (AP) in a wireless network (e.g., a wireless local area network (WLAN)), a client (also referred to as a station) in the network, and the like.

In the illustrated example, the wireless device 700 includes a radio frequency integrated circuit (RFIC) 750 and a set of antenna elements 702 to facilitate wireless transmission and/or reception of radio frequency (RF) signals for the wireless device 700. The RFIC 750 comprises or is coupled to two radios 755A and 755B (collectively, the radios 755 and/or wireless radios 755). Generally, the radios 755 may operate in the same or adjacent frequency bands in some aspects. For example, each of the radios 755 may operate in the 5 GHz and/or 6 GHz band(s). Although two radios 755 are depicted for conceptual clarity, in some aspects, the wireless device 700 may include any number of radios 755. Further, although two antenna elements 702 are depicted for conceptual clarity, in some aspects, the wireless device 700 may include any number of antenna elements 702. In some embodiments, the wireless device 700 may include a number of antenna elements 702 equal to the number of RF chains 770 in each radio 755.

In the illustrated example, each radio 755 includes two RF chains 770. Specifically, the radio 755A includes RF chains 770A and 770B, and the radio 755B includes RF chains 770C and 770D. As used herein, an RF chain 770 is generally representative of a transceiver (also referred to in some embodiments as a transceiver element and/or transmitter/receiver pair) and associated components (e.g., attenuators, amplifiers, switches, and the like) used to transmit and/or receive RF signals. In the illustrated example, each RF chain 770 includes at least a transmitter component 760, a receiver component 765 (or, collectively, a transceiver component), and a switch 775.

Specifically, in the illustrated example, the RF chain 770A includes a transmitter 760A, a receiver 765A, and a switch 775A. The RF chain 770B includes a transmitter 760B, a receiver 765B, and a switch 775B, the RF chain 770C includes a transmitter 760C, a receiver 765C, and a switch 775C, and the RF chain 770D includes a transmitter 760D, a receiver 765D, and a switch 775D.

As illustrated, each RF chain 770 is coupled to a corresponding conductor 710 of an antenna element 702 via a connection 780 (e.g., a wire or trace). In the illustrated example, each of the antenna elements 702A and 702B (collectively, antenna elements 702) may correspond to the antenna element 202 of FIG. 2, the antenna element 302 of FIG. 3, the antenna element 402 of FIG. 4, the antenna element 502 of FIG. 5, and/or the antenna element depicted above in FIG. 6. Generally, each antenna element 702 includes two conductors 710 arranged in an orthogonal manner, as discussed above. Although the illustrated example depicts bowtie conductors, the design of the conductors 710 may vary depending on the particular implementation, and may correspond to (without limitation) the antenna designs 100A, 100B, and/or 100C of FIG. 1. Generally, the particular size and shape of each conductor 710 may vary depending on the particular implementation (e.g., based on the frequency band(s) in which the antennas will be used).

In the illustrated example, the RF chains 770 of each radio 755 are coupled to a corresponding set of conductors of the antenna elements 702. That is, the RF chains 770 from one radio (e.g., the radio 755A) are coupled to the upper conductors 710 of the antenna elements 702, and the RF chains 770 from the other radio 755B are coupled to the lower conductors 710 of the antenna elements 702. Specifically, the RF chain 770A of the radio 755A is coupled to the (upper) conductor 710A of the antenna element 702A (via the connection 780A), the RF chain 770B of the radio 755A is coupled to the (upper) conductor 710C of the antenna element 702B (via the connection 780C), the RF chain 770C of the radio 755B is coupled to the (lower) conductor 710B of the antenna element 702A (via the connection 780C), and the RF chain 770D of the radio 755B is coupled to the (lower) conductor 710D of the antenna element 702B (via the connection 780D).

In this way, as discussed above, the conductors used by the radio 755A are orthogonal to the antenna used by the radio 755B, improving RF isolation and reducing (or eliminating) interference between the radios 755, even when operating in the same or adjacent frequencies. In some aspects, the conductors 710 used by each radio 755 may be coplanar with each other. That is, the conductors 710 coupled to a first radio (e.g., the radio 755A) may each be coplanar with each other, while the conductors 710 coupled to a second radio (e.g., the radio 755B) may each be coplanar with each other (while not being coplanar with the conductors 710 for the radio 755A). Specifically, in the illustrated example, the upper conductors 710A and 710C may be coplanar with each other and the lower conductors 710B and 710D may be coplanar with each other.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless device, comprising:
a first wireless radio configured to operate in a first set of frequency bands;
a second wireless radio configured to operate in a second set of frequency bands;
a first dipole antenna coupled to the first wireless radio; and
a second dipole antenna coupled to the second wireless radio, wherein a plane of the second dipole antenna is parallel to a plane of the first dipole antenna, and the second dipole antenna is orthogonal to the first dipole antenna.

2. The wireless device of claim 1, wherein the first set of frequency bands comprises one or more frequency bands that are adjacent to one or more frequency bands of the second set of frequency bands.

3. The wireless device of claim 1, wherein the first set of frequency bands comprises one or more frequency bands that are overlapping with one or more frequency bands of the second set of frequency bands.

4. The wireless device of claim 1, wherein:
the first wireless radio comprises a first plurality of transceiver elements,
the second wireless radio comprises a second plurality of transceiver elements,
the first dipole antenna is coupled to a first transceiver element of the first plurality of transceiver elements,
the second dipole antenna is coupled to a first transceiver element of the second plurality of transceiver elements, and
the wireless device further comprises:
a third dipole antenna coupled to a second transceiver element of the first plurality of transceiver elements; and
a fourth dipole antenna coupled to a second transceiver element of the second plurality of transceiver elements, wherein a plane of the third dipole antenna is parallel to a plane of the fourth dipole antenna, and the fourth dipole antenna is orthogonal to the third dipole antenna.

5. The wireless device of claim 1, wherein the first dipole antenna creates an electric field that is orthogonal to an electric field created by the second dipole antenna.

6. The wireless device of claim 1, further comprising a dielectric material between the first and second dipole antennas.

7. The wireless device of claim 1, further comprising a set of pillars separating the first and second dipole antenna.

8. The wireless device of claim 1, wherein each of the first and second dipole antennas comprise a respective bowtie conductor.

9. The wireless device of claim 1, wherein each of the first and second dipole antennas comprise a respective magnetic loop conductor.

10. An apparatus, comprising:
a first dipole antenna;
a second dipole antenna, wherein a plane of the second dipole antenna is parallel to a plane of the first dipole antenna, and a major axis of the second dipole antenna is perpendicular to a major axis of the first dipole antenna; and
a dielectric material between the first and second dipole antennas.

11. The apparatus of claim 10, further comprising:
a first wireless radio configured to operate in a first set of frequency bands and coupled to the first dipole antenna; and
a second wireless radio configured to operate in a second set of frequency bands and coupled to the second dipole antenna.

12. The apparatus of claim 11, wherein the first set of frequency bands comprises one or more frequency bands that are adjacent to or overlapping with one or more frequency bands of the second set of frequency bands.

13. The apparatus of claim 11, wherein:
the first wireless radio comprises a first plurality of transceiver elements,
the second wireless radio comprises a second plurality of transceiver elements,
the first dipole antenna is coupled to a first transceiver element of the first plurality of transceiver elements,
the second dipole antenna is coupled to a first transceiver element of the second plurality of transceiver elements, and
the apparatus further comprises:
a third dipole antenna coupled to a second transceiver element of the first plurality of transceiver elements; and
a fourth dipole antenna coupled to a second transceiver element of the second plurality of transceiver elements, wherein a plane of the third dipole antenna is parallel to a plane of the fourth dipole antenna, and the fourth dipole antenna is orthogonal to the third dipole antenna.

14. The apparatus of claim 10, wherein the first dipole antenna creates an electric field that is orthogonal to an electric field created by the second dipole antenna.

15. The apparatus of claim 10, further comprising a set of pillars separating the first and second dipole antenna.

16. The apparatus of claim 10, wherein each of the first and second dipole antennas comprise a respective bowtie conductor.

17. The apparatus of claim 10, wherein each of the first and second dipole antennas comprise a respective magnetic loop conductor.

18. An access point (AP), comprising:
a first wireless radio comprising a first plurality of transceiver elements and configured to operate in a first set of frequency bands;
a second wireless radio comprising a second plurality of transceiver elements and configured to operate in a second set of frequency bands;
a first dipole antenna coupled to a first transceiver element of the first set of transceiver elements;
a second dipole antenna coupled to a first transceiver element of the second plurality of transceiver elements, wherein a plane of the second dipole antenna is parallel to a plane of the first dipole antenna, and the second dipole antenna is orthogonal to the first dipole antenna;
a third dipole antenna coupled to a second transceiver element of the first plurality of transceiver elements; and
a fourth dipole antenna coupled to a second transceiver element of the second wireless radio, wherein a plane of the third dipole antenna is parallel to a plane of the fourth dipole antenna, and the fourth dipole antenna is orthogonal to the third dipole antenna.

19. The AP of claim 18, further comprising:
a first antenna element comprising:
the first and second dipole antennas; and
a dielectric material between the first and second dipole antennas; and
a second antenna element comprising:
the third and fourth dipole antennas; and
a dielectric material between the third and fourth dipole antennas.

20. The AP of claim 18, wherein:
the plane of the first dipole antenna and the plane of the third dipole antenna are coplanar; and
the plane of the second dipole antenna and the plane of the fourth dipole antenna are coplanar.
